(19) United States
(12) Patent Application Publication
(10) Pub. No.: US 2007/0291213 A1
(43) Pub. Date: Dec. 20, 2007

(54) LIQUID CRYSTAL DISPLAY

(76) Inventors: Ying-Ru Chen, Hsin-Chu (TW); Mu-Jen Su, Hsin-Chu (TW); Ching-Huan Lin, Hsin-Chu (TW); Chih-Ming Chang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/610,521

(22) Filed: Dec. 14, 2006

(30) Foreign Application Priority Data
Jun. 19, 2006 (TW) 095121885

(51) Int. Cl. G02F 1/1343

(52) U.S. Cl. 349/143

(57) ABSTRACT

A liquid crystal display panel is disclosed. The liquid crystal display panel includes a first substrate and a second substrate, a liquid crystal layer disposed between the first substrate and the second substrate, a pixel, and a first protrusion and a second protrusion. The pixel includes a first pixel electrode, a second pixel electrode, and a plurality of bridge electrodes disposed on the second substrate, in which the bridge electrodes are electrically connected to the first pixel electrodes and the second electrodes. The first protrusion and a second protrusion are disposed on the first substrate with respect to the first pixel electrode and the second pixel electrode.

This application claims benefit to a Taiwanese Patent Application No. 095121885, filed on Jun. 19, 2006.

### BACKGROUND OF THE INVENTION

1. Field of the Invention

The invention relates to a liquid crystal display panel, and more particularly, to a multi-domain vertical alignment liquid crystal display panel.

2. Description of the Prior Art

Liquid crystal displays (LCDs) are commonly utilized in various electronic products including cell phones, PDAs, and notebook computers. As the market demand for flat display panels continues to increase, LCDs become popular due to the advantages such as thin and lightweight. In fact, LCDs are gradually replacing cathode ray tube (CRT) displays that had dominated the market for so many years. However, the viewing angle of a conventional liquid crystal display is not wide enough to ensure a high display quality, therefore, multi-domain vertical alignment (MVA) displays capable of orientating liquid crystals in various directions are proposed to improve the above problem.

Please refer to FIG. 1 and FIG. 2. FIG. 1 is a plan view diagram illustrating a conventional pixel of a multi-domain vertical alignment liquid crystal display panel 10, and FIG. 2 is a cross-section diagram of FIG. 1 along the sectional line AA′. As shown in FIG. 1 and FIG. 2, the multi-domain vertical alignment liquid crystal display panel 10 includes an upper substrate 12, a lower substrate 14, a liquid crystal layer 16 composed of negative type liquid crystals between the upper substrate 12 and the lower substrate 14, a common electrode 18 disposed on a surface of the upper substrate 12, a plurality of color filters (not shown) between the upper substrate 12 and the common electrode 18, a first pixel electrode 20 and a second pixel electrode 28 disposed between the liquid crystal layer 16 and the lower substrate 14, and a first protrusion 22 and a second protrusion 30 disposed on the common electrode 18 corresponding to the lower substrate 14.

The first pixel electrode 20 and the second pixel electrode 28 can be transmissive electrodes composed of indium tin oxide (ITO) or indium zinc oxide (IZO), or reflective electrodes composed of aluminum. The first pixel electrode 20 and the second pixel electrode 28 are separated by a primary slit 26 and connected by a single rectangular bridge electrode 24, in which the bridge electrode 24 can be a transmissive electrode. As shown in FIG. 1, the primary slit 26 has a width d and the bridge electrode 24 has a width w, in which a sufficient value of the width d is able to provide an adequate alignment for the liquid crystals between the first pixel electrode 20 and the second pixel electrode 28.

In general, the stability of the liquid crystal alignment and the uniformity of the pixel region are determined by the liquid crystals ability to achieve a ±90° angle above the bridge electrode. Ideally, when a ±90° angle is found directly with respect to the center of the pixel, a maximum stability for the alignment of liquid crystals can be achieved. In other cases, the alignment of the liquid crystals will vary and become unstable as the viewing angle changes. Preferably, when the primary slit 26 has a sufficient width, a strong fringe field effect will allow the liquid crystals to generate a ±90° angle relative to the center of the pixel, thereby achieving a stable alignment of the liquid crystals. However, by doing this, the aperture ratio of the display will be affected significantly. On the other hand, if the width of the primary slit 26 is reduced to increase the aperture ratio, an insufficient fringe field effect will cause the liquid crystals located relative to the center of the pixel to achieve an angle less than or greater than ±90°, as indicated by the arrow shown in FIG. 1. For instance, a pixel of a 1.9 inch panel typically has a size of 56.5 microns by 169.5 microns, in which the width d of the primary slit is 10 microns and the width w of the bridge electrode is 6 microns. However, as the width d of the primary slit is reduced to 6 microns and the width w of the bridge electrode is maintained at 6 microns to increase the aperture ratio, an insufficient fringe field effect will occur and the alignment of the liquid crystals become unstable.

Additionally, since the angle of the liquid crystals is primarily determined by the magnitude of the electric field, such as the effect from the protrusions and the primary slits, a conventional single bridge electrode design often induces a dragging force to shift the liquid crystals toward right or left. Ultimately, the ±90° angle of the liquid crystals relative to the center of the bridge electrode will not be achieved, and thus influences the balance of the liquid crystals.

### SUMMARY OF THE INVENTION

It is therefore an object of the present invention to provide a multi-domain vertical alignment liquid crystal display panel to improve the aforementioned unstable alignment problem of the liquid crystals.

A liquid crystal display panel is disclosed. The liquid crystal display panel includes a first substrate and a second substrate, a liquid crystal layer disposed therebetween, a pixel, and a first protrusion and a second protrusion. The pixel includes a first pixel electrode, a second pixel electrode, and a plurality of bridge electrodes disposed on the second substrate, wherein the bridge electrodes are electrically connected to the first pixel electrodes and the second electrodes. The first protrusion and a second protrusion are disposed on the first substrate with respect to the first pixel electrode and the second pixel electrode.

Preferably, the present invention utilizes two or more bridge electrodes to connect two pixel electrodes, such that a potential well generated between the two bridge electrodes can be utilized to improve the problem of weak fringe field and unstable alignment of the liquid crystals above the bridge electrode. Additionally, by improving the conventional single electrode design that limits the width of the primary slit between two pixel electrode, the present invention not only achieves a uniform distribution and alignment of the liquid crystals, but also increases the aperture ratio of the pixels while maintaining the width of the primary slit constant.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a plan view diagram illustrating a conventional pixel of a multi-domain vertical alignment liquid crystal display panel.

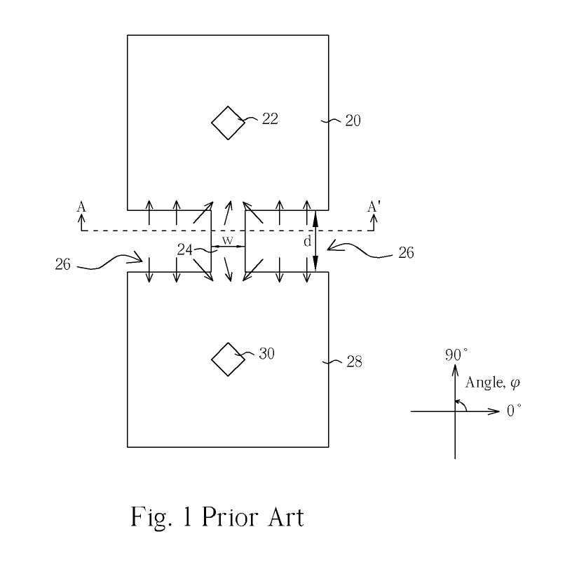

FIG. 2 is a cross-section diagram of FIG. 1 along the sectional line AA′.

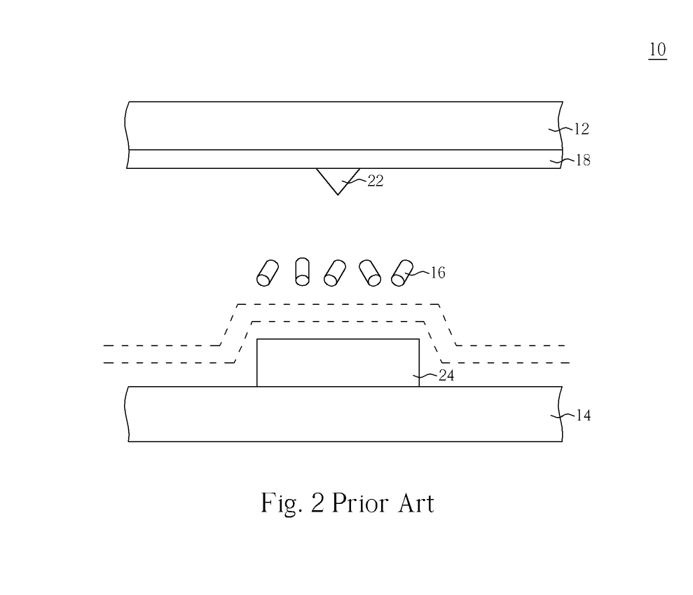

FIG. 3 is a plan view diagram illustrating a pixel of a multi-domain vertical alignment liquid crystal display panel according to an embodiment of the present invention.

FIG. 4 is a cross-section diagram of FIG. 3 along the sectional line BB′.

FIG. 5 is a plan view diagram illustrating a pixel of a multi-domain vertical alignment liquid crystal display panel according to an embodiment of the present invention.

FIG. 6 is a plan view diagram illustrating a pixel of a multi-domain vertical alignment liquid crystal display panel according to another embodiment of the present invention.

FIG. 7 is a plan view diagram illustrating a pixel of a multi-domain vertical alignment liquid crystal display panel according to another embodiment of the present invention.

FIG. 8 is a comparison table illustrating the aperture ratios of single bridge electrode design and double bridge electrodes design under different resolution.

### DETAILED DESCRIPTION

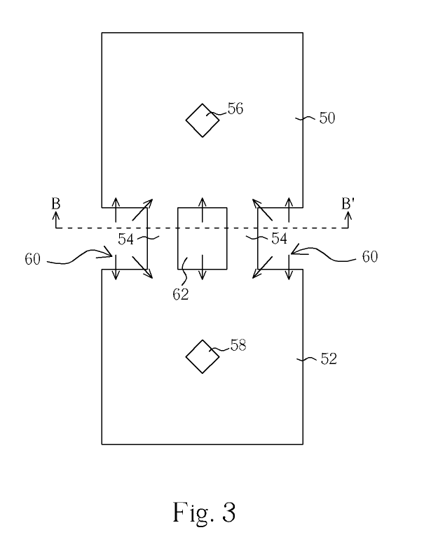

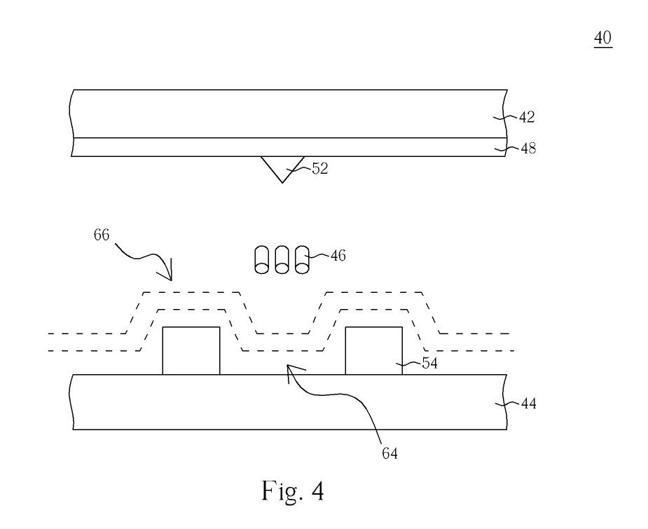

Please refer to FIG. 3 and FIG. 4. FIG. 3 is a plan view diagram illustrating a pixel of a multi-domain vertical alignment liquid crystal display panel 40 according to an embodiment of the present invention, and FIG. 4 is a cross-section diagram along the sectional line BB′ of FIG. 3. As shown in FIG. 3 and FIG. 4, the multi-domain vertical alignment liquid crystal display panel 40 includes an upper substrate 42, a lower substrate 44, a liquid crystal layer 46 composed of negative type liquid crystals between the upper substrate 42 and the lower substrate 44, a common electrode 48 disposed on a surface of the upper substrate 42, a plurality of color filters (not shown) between the upper substrate 42 and the common electrode 48, a first pixel electrode 50 and a second pixel electrode 52 disposed on the lower substrate 44, a plurality of rectangular bridge electrodes 54 disposed on the lower substrate 44 and electrically connected to the first pixel electrode 50 and the second pixel electrode 52, and a first protrusion 56 and a second protrusion 58 disposed on the upper substrate 42 with respect to the first pixel electrode 50 and the second pixel electrode 52.

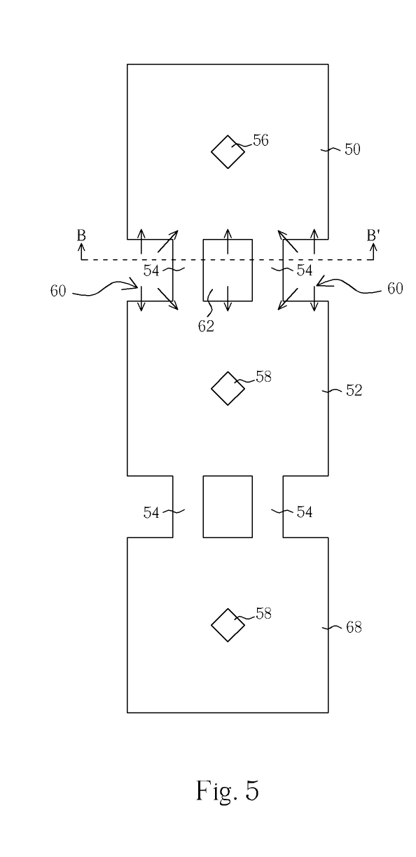

The first pixel electrode 50 and the second pixel electrode 52 can be transmissive electrodes composed of indium tin oxide (ITO) or indium zinc oxide (IZO), or reflective electrodes composed of aluminum. The first protrusion 56 and the second protrusion 58 are respectively disposed relative to the center of the first pixel electrode 50 and the second pixel electrode 52, in which the bottom of the first protrusion 56 and the second protrusion 58 can be rectangular or circular. Additionally, the first pixel electrode 50 and the second pixel electrode 52 have a primary slit 60 therebetween and the bridge electrodes 54 also include a secondary slit 62 therebetween, in which the bridge electrodes 54 are symmetrical to the first protrusion 56 and the second protrusion 58. According to an embodiment of the present invention, as shown in FIG. 5, the multi-domain vertical alignment liquid crystal display panel 40 may also include a third pixel electrode 68 disposed on the lower substrate 44 and a protrusion 58 disposed with respect to the third pixel electrode 68. Preferably, the third pixel electrode 68 is connected to the second pixel electrode 52 via a plurality of bridge electrodes 54. Similar to the first pixel electrode 50 and the second pixel electrode 52, the third pixel electrode 68 can be either a transmissive electrode or a reflective electrode.

It should be noted that the spot between two bridge electrodes 54, such as the location of the secondary slit 62, includes a potential well 64, in which the potential well 64 has lower potential compared with the bridge electrodes 54. In other words, by utilizing the relatively lower potential well formed between the two bridge electrodes 54 to restrain the negative type liquid crystals within the liquid crystal layer, the liquid crystals can be stabilized significantly by achieving a ±90° angle.

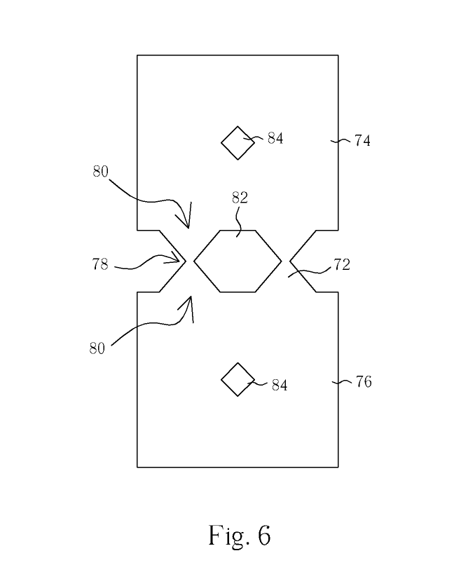

Please refer to FIG. 6. FIG. 6 is a plan view diagram illustrating a pixel of a multi-domain vertical alignment liquid crystal display panel according to an embodiment of the present invention. As shown in FIG. 6, the protrusions 84 of the multi-domain vertical alignment liquid crystal display panel are positioned corresponding to the first pixel electrode 74 and the second pixel electrode 76 respectively, and a plurality of bridge electrodes 72 is utilized to connect the first pixel electrode 74 and the second pixel electrode 76. In contrast to the rectangular bridge electrodes described previously, the bridge electrodes 72 of the present embodiment includes a central portion 78 and two end portions 80, in which the width of each end portion 80 is greater than the width of the central portion 78. Additionally, a secondary slit 82 formed between the first pixel electrode 74 and the second pixel electrode 76 also includes a potential well, in which the potential well formed at the secondary slit 82 is lower than the adjacent potential formed corresponding to each of the bridge electrodes 72. By utilizing the potential well to restrain the negative type liquid crystals within the liquid crystal layer, the liquid crystals are able to achieve a much more stable alignment. Moreover, the present embodiment may also include a third pixel electrode (not shown) disposed below the second pixel electrode 76, in which the third pixel electrode is connected to the second pixel electrode 76 via a plurality of bridge electrodes (not shown) to form a pixel of a multi-domain vertical alignment liquid crystal display panel.

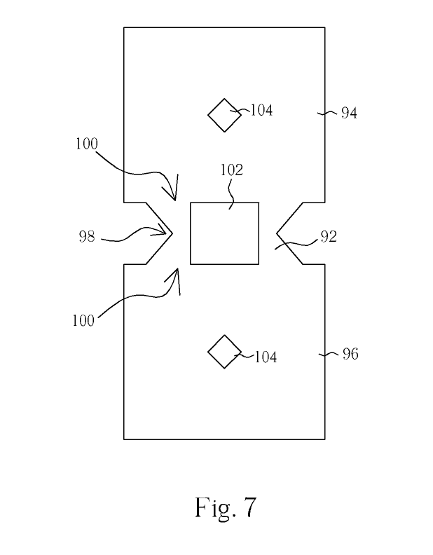

Please refer to FIG. 7. FIG. 7 is a plane view diagram illustrating a pixel of a multi-domain vertical alignment liquid crystal display panel according to an embodiment of the present invention. As shown in FIG. 7, the protrusions 104 of the multi-domain vertical alignment liquid crystal display panel are positioned corresponding to the first pixel electrode 94 and the second pixel electrode 96 respectively, and a plurality of bridge electrodes 92 is utilized to connect the first pixel electrode 94 and the second pixel electrode 96. Similarly, the bridge electrodes 92 also include a central portion 98 and two end portions 100, in which the width of each end portion 100 is greater than the width of the central portion 98. In contrast to the previous embodiment, the secondary slit 102 of the present embodiment is rectangular. Preferably, the secondary slit 102 also include a potential well, in which the potential well formed at the secondary slit 102 is lower than the adjacent potential formed corresponding to each of the bridge electrodes 92, thereby allowing the liquid crystals to achieve a much more stable alignment.

Hence, in contrast to the conventional means of utilizing a single bridge electrode to connect two pixel electrodes, the present invention utilizes two or more bridge electrodes to connect two pixel electrodes, such that a lower potential well generated between the two bridge electrodes can be utilized to improve the problem of weak fringe field and unstable alignment of the liquid crystals on the bridge electrode. Additionally, by improving the conventional single electrode design of limiting the width of the primary slit between two pixel electrode, the present invention not only achieves a uniform distribution and alignment of the liquid crystals, but also increases the aperture ratio of the pixels while maintaining the width of the primary slit constant.

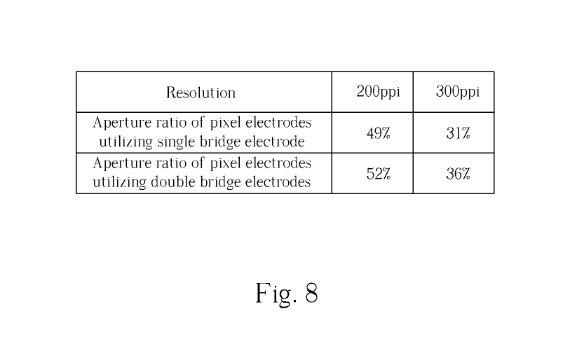

Please refer to FIG. 8. FIG. 8 is a comparison diagram illustrating the aperture ratio of single bridge electrode and double bridge electrodes under different resolution. In general, the primary slit of the conventional single bridge electrode design must reach a width of 10 μm to achieve a stable alignment for the liquid crystals. According to the preferred embodiment of the present invention, the primary slit of the double bridge electrode design requires a width of 6 μm. Additionally, under the resolution of 200 ppi and 300 ppi, the aperture ratio of the single bridge electrode design is 49% and 31%, whereas the aperture ratio of the double bridge electrode design is 52% and 36% respectively. Hence, the double bridge electrode design not only increase the overall aperture ratio of the display, but also significantly increase the aperture ratio under higher resolution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display panel, comprising:
a first substrate and a second substrate;
a liquid crystal layer, disposed between the first substrate and the second substrate;
a pixel having a first pixel electrode, a second pixel electrode, and a plurality of bridge electrodes disposed on the second substrate, wherein the bridge electrodes are electrically connected to the first pixel electrodes and the second electrodes; and
a first protrusion and a second protrusion, disposed on the first substrate with respect to the first pixel electrode and the second pixel electrode.

2. The liquid crystal display panel of claim 1, wherein the first protrusion and the second protrusion are disposed corresponding to a center of the first pixel electrode and the second pixel electrode.

3. The liquid crystal display panel of claim 1, wherein the bridge electrodes are rectangular electrodes.

4. The liquid crystal display panel of claim 1, wherein the bridge electrodes have a central portion and two end portions, wherein the width of each end portion is greater than the width of the central portion.

5. The liquid crystal display panel of claim 1, wherein the bridge electrodes are symmetrical with respect to the first protrusion and the second protrusion.

6. The liquid crystal display panel of claim 1, further comprising a primary slit positioned between the first pixel electrode and the second pixel electrode, wherein the bridge electrodes are disposed within the primary slit.

7. The liquid crystal display panel of claim 1, wherein the bridge electrodes comprise a secondary slit therein between.

8. The liquid crystal display panel of claim 7, wherein a potential formed on each bridge electrode is greater than a potential formed on each secondary slit.

9. The liquid crystal display panel of claim 7, wherein a potential well formed on each secondary slit facilitates a ±90° angle for liquid crystals.

10. The liquid crystal display panel of claim 1, wherein the liquid crystal layer comprises negative type liquid crystals.

11. The liquid crystal display panel of claim 1, further comprising a common electrode disposed on the first substrate.

12. The liquid crystal display panel of claim 11, further comprising a plurality of color filters disposed between the first substrate and the common electrode.

13. The liquid crystal display panel of claim 1, wherein the first pixel electrode and the second electrode are transmissive electrodes or reflective electrodes.

14. The liquid crystal display panel of claim 1, further comprising a third pixel electrode disposed on the second substrate and electrically connected to the second pixel electrode.

15. The liquid crystal display panel of claim 14, where in the third electrode is a transmissive electrode or a reflective electrode.

16. The liquid crystal display panel of claim 14, wherein the first pixel electrode, the second pixel electrode, and the third pixel electrode comprise indium tin oxide or indium zinc oxide.

17. The liquid crystal display panel of claim 1 further comprising a plurality of thin film transistors disposed on the second substrate.

18. The liquid crystal display panel of claim 1, wherein a bottom of the first protrusion and the second protrusion is circular or rectangular.
